(19) United States
(12) Patent Application Publication
(10) Pub. No.: US 2010/0170580 A1
(43) Pub. Date: Jul. 8, 2010

(54) WATER FAUCET ANTI-THEFT DEVICE

(76) Inventors: Cory Bott, American Fork, UT (US); Jeffrey Glen Bott, Castle Dale, UT (US); Jerry Glen Bott, Castle Dale, UT (US)

Correspondence Address: Steven L. Rinehart, 1059 E. Millstream Way, Bountiful, UT, 84010, US

(21) Appl. No.: 12/349,523

(22) Filed: Jan. 7, 2009

(51) Int. Cl. F16L 35/00

(52) U.S. Cl. 137/377

(57) ABSTRACT

An apparatus is disclosed for protecting standard water faucets from unauthorized use. The water faucet anti-theft device protects water faucets from unauthorized use by locking a rigid housing around said facet to prevent unauthorized activation of the faucet's spigot. The water faucet anti-theft device, in the preferred embodiment, comprises three housing segments which latchably engage one another around the faucet to form an assembled housing, which may be locked in its assembled state. The apparatus includes padlocks, and other locking mechanisms, necessary to serve a variety of needs.

### FIELD OF THE INVENTION

This invention relates to anti-theft devices, and more particularly relates to a device for protecting water faucets from unauthorized use by locking a rigid housing around said facet to prevent unauthorized activation of the faucet's spigot.

### BACKGROUND

### Description of the Related Art

In many areas the world and United States, water is becoming increasingly valuable. In the southwest United States, water supplies are ever more scarce, and the cost of water supplied by public utility companies and the like to the public is expected to increase dramatically in the near future. Water theft has always been a problem particularly in arid regions of the southwest, and becoming progressively more problematic.

Many building structures, both residential and commercial, are built with water faucets located in various easy-access locations around the structures, both within and without. The faucets are designed to provide water to anyone who turns a spigot, or valve, on the faucet. It is common for thieves to connect hoses and/or tanks of various species to unattended faucets and pilfer water from them without authorization. Often home owners in residential suburban areas will steal water from their neighbors while they are out of town or their home is known to be unattended. Other types of liquids and gases dispensed from faucets for other purposes are also frequently stolen, including gas, natural gas, syngas and beer.

Because billing cycles from public utility companies and other water providers vary, it can be difficult to detect the theft or increased water usage until long after it has occurred, or to apprehend or identify the thieves responsible.

### SUMMARY

From the foregoing discussion, it should be apparent that a need exists for an apparatus to protect faucets from unauthorized use. Beneficially, such an apparatus and method would incorporate a locking mechanism configured to allow only an authorized user in possession of a key or combination to access the faucet.

The present invention has been developed in response to the present state of the art, and in particular, in response to the problems and needs in the art that have not yet been fully solved by currently available photovoltaic systems. Accordingly, the present invention has been developed to provide an apparatus and method for levitating a solar array that overcome many or all of the above-discussed shortcomings in the art.

The apparatus which protects water faucets from unauthorized access is provided with a plurality of modules configured to impart the necessary functionality to apparatus. The apparatus, or water faucet anti-theft device, comprises a forward housing segment with two or more spaced-apart walls defining a cavity encapsulating a spout of a faucet, the forward housing segment configured to slide relative to the faucet over the spout and to cover the forward, lateral and lower portions of the faucet.

The apparatus further comprises an upper housing segment comprising two or more spaced-apart walls defining a cavity encapsulating one of the faucet or the forward housing segment, the upper housing segment configured to slide relative to the faucet over the upper and lateral portions of the faucet, and a rearward housing segment configured to slide relative to the faucet behind the faucet, and to cover the rearward portion of the faucet.

The apparatus also comprises two or more semi-circular protrusions mounted to one or more of the housing segments and configured to receive the locking bar of a padlock once the upper housing segment, rearward housing segment and forward housing segment have been assembled around the faucet (together the “assembled housing”).

In some embodiments, the apparatus further comprises two or more semi-circular protrusions mounted to one or more of the housing segments in the assembled housing and configured to receive the shackle of a padlock once the upper housing segment, rearward housing segment and forward housing segment have been assembled around the faucet.

The apparatus, in certain embodiment, is modified such that the upper housing segment, the rearward housing segment, and the forward housing segment comprise a key-operated latching release mechanism for releasing each of the upper housing segment, the rearward housing segment, and the forward housing segment, after said segments are assembled together, wherein said key-operated latching mechanism is activated with a key or combination.

The apparatus may also be modified, in further embodiment, such that the upper housing segment is configured to latchably engage at least one of the forward housing segment one of the rearward housing segment, and wherein the rearward housing segment is configured to latchably engage at least one of the forward housing segment and the upper housing segment.

The rearward housing segment may also be rotatably connected to one of the forward housing segment and the upper housing segment.

In still further embodiments, the apparatus is modified such that the upper housing segment comprises one or more oblong holes through which push-buttons affixed to the one or more of the forward housing segment and the rearward housing segment protrude when the segments are assembled to form the assembled housing, which push-buttons are configured to slidably release one or more housing segments from the assembled housing when depressed.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a stylized view of one embodiment of the disassembled water faucet anti-theft device in accordance with the present invention;

FIG. 1B is an alternative stylized view of a portion of the assembled water faucet anti-theft device in accordance with the present invention; and

FIG. 2 is an alternative stylized view of a water faucet anti-theft device in a different configuration in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

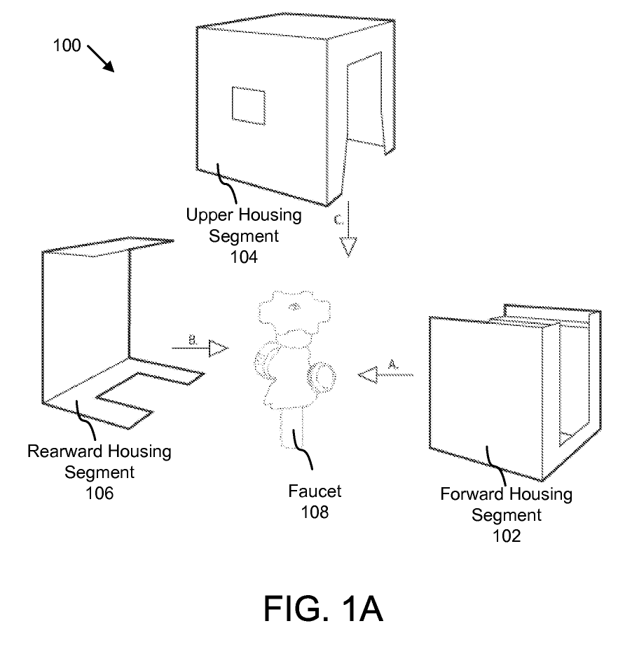

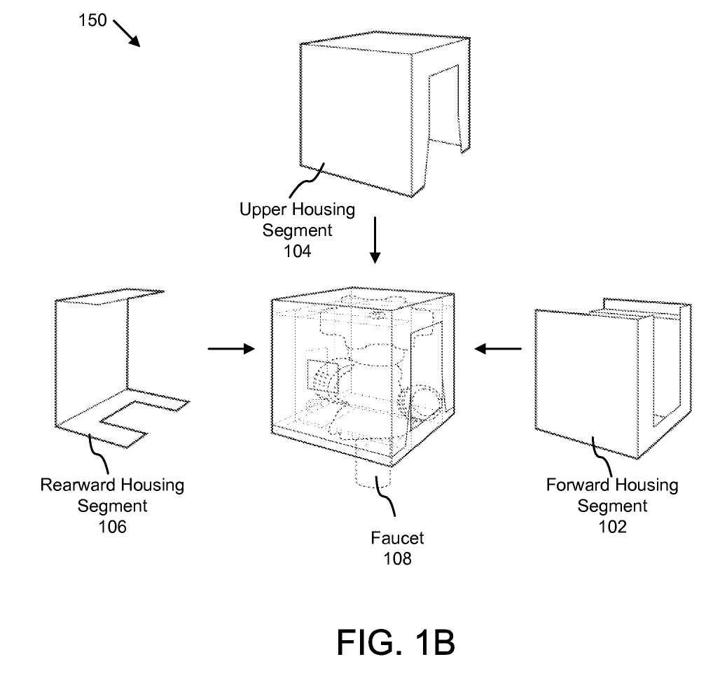

FIG. 1A is a stylized view of one embodiment of the disassembled water faucet anti-theft device 100 in accordance with the present invention. FIG. 1 includes a forward housing segment 102, an upper housing segment 104, a rearward housing segment 106, and a faucet 108.

The forward housing segment 102 comprises two or more spaced-apart walls defining a cavity which can partially encapsulate a spout of the faucet 108, or the forward section of the faucet 108. The forward housing segment 102 may be detachably or rotatably connected to the upper housing segment 104 and/or the rearward housing segment 106. The forward housing segment 102 may be made of any rigid material, including metals, woods, polymers, glass, or other materials well known to those of skill in the art. The forward housing segment 102 is configured to slide relative to the faucet over the spout and to cover the forward, lateral and lower portions of the faucet. The forward housing segment 102 may also snap onto the faucet 108 rather than slide, or be simply positioned around faucet 108 in such a manner as to prevent a spigot or valve that activates the faucet 108 from being turned once the forward housing segment 102 is positioned around the faucet 108.

The upper housing segment 104, in some embodiments, comprises two or more spaced-apart walls further defining a cavity which can partially encapsulate a spout of the faucet 108. Alternatively, the cavity may simply encapsulate, support, or partially encapsulate, the forward section of the faucet 108. The upper housing segment 104 may be detachably or rotatably connected to the forward housing segment 102 and/or the rearward housing segment 106. The upper housing segment 104 may be made of any rigid material, including metals, woods, polymers, glass, or other materials well known to those of skill in the art. The upper housing segment 104 is configured to slide relative to the faucet over the faucet and to cover the faucet's lateral and upper portions. The upper housing segment 104 may also snap onto the faucet 108, or other segments of the apparatus, rather than slide, or be simply positioned around faucet 108 in such a manner as to prevent a spigot or valve that activates the faucet 108 from being turned once the upper housing segment 104 is positioned around the faucet 108, or once the upper housing segment 104 is positioned with other segments of the apparatus 100 around the faucet 108.

The rearward housing segment 106, in some embodiments, covers the rearward portion of the faucet 108, and/or forms the rearward portion of the cavity encapsulating the faucet 108. The rearward housing segment 106 may be detachably or rotatably connected to the forward housing segment 102 and/or the upper housing segment 104. The rearward housing segment 106 may be made of any rigid material, including metals, woods, polymers, glass, or other materials well known to those of skill in the art. The rearward housing segment 106 is configured to slide relative to the faucet over the faucet and to cover the faucet's lateral and upper portions. The rearward housing segment 106 may also snap onto the faucet 108, or other segments of the apparatus, rather than slide, or be simply positioned around faucet 108 in such a manner as to prevent a spigot or valve that activates the faucet 108 from being turned once the rearward housing segment 106 is positioned around the faucet 108, or once the rearward housing segment 106 is positioned with other segments of the apparatus 100 around the faucet 108.

The faucet 108 is well known to those of skill in the art. The faucet 108 comprises a tap for controlling the release of a gas or liquid, usually water. For the purposes of this invention, the term “valve” describes the mechanism which stops and starts the flow of a liquid or gas through the faucet 108, including faucets comprising screw-down mechanisms well-known to those of skill in the art. The faucet 108 may used indoors or outdoors. The faucet 108 usually comprises a valve. The faucet 108 may be an adjustable flow faucet, or of the thermostat mixing valve variety or gate valve variety. Types of liquids and gases dispensed from faucets include gas, natural gas, syngas and beer.

In the preferred embodiment, the water faucet anti-theft device 100 is assembled by first placing the forward housing segment 102 on the faucet, followed by the upper housing segment 104, followed by the rearward housing segment 106.

FIG. 1B is an alternative stylized view of a portion of the assembled water faucet anti-theft device 150 in accordance with the present invention. The apparatus 150 includes a forward housing segment 102, an upper housing segment 104, a rearward housing segment 106, and a faucet 108.

The forward housing segment 102 is substantially described above in relation to FIG. 1A.

The upper housing segment 104 is substantially described above in relation to FIG. 1A.

The rearward housing segment 106 is substantially described above in relation to FIG. 1A.

The faucet is substantially described above in relation to FIG. 1A.

FIG. 1B illustrates one embodiment of the water faucet anti-theft device 150 in which the faucet 108 in fully encapsulated by the apparatus 150. In other embodiments, the lower portion of the faucet 108, or the faucet's spigot, or other portions of the faucet, protrude out from openings in the assembled housing 100.

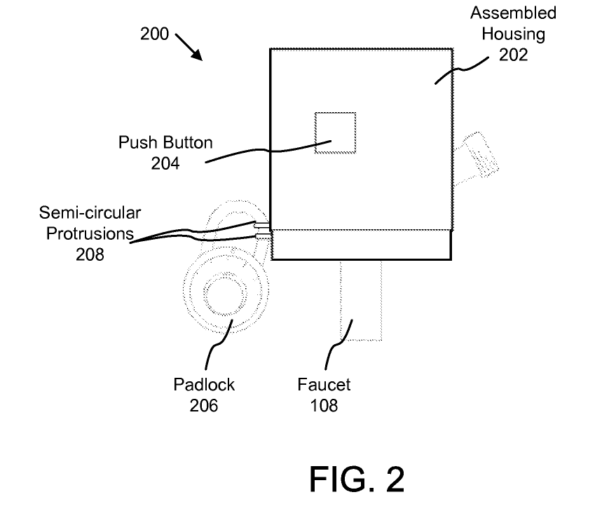

FIG. 2 is an alternative stylized view of a water faucet anti-theft device 200 in a different configuration in accordance with the present invention. The apparatus 200 in FIG. 2 substantially includes the embodiments and modules described above with regard to the apparatus depicted in FIGS. 1A-1B. The apparatus 200 includes an assembled housing 202, a push button 204, a padlock 206, semi-circular protrusions 208, and a faucet 108.

The assembled housing 202 comprises the forward housing segment 102, the upper housing segment 104, and the rearward housing segment 106, all latchably connected to one another around the faucet 108. The faucet 108 fills a cavity within the assembled housing 202 created by assembling the housing segments 102-106.

The push button 204 is well-known to those of skill in the art. The push button 204 is affixed, in the preferred embodiment, to the forward housing segment 102 and protrudes through a hole in the upper housing segment 104 such that when the push button 204 is depressed, the forward housing segment 102 detaches slidably from the upper housing segment 104. The hole through which the push button 204 protrudes may be circular, square, or oblong in shape.

In alternate embodiments, the push button 204 protrudes through a hole in the forward housing segment 104 or the rearward housing segment 106, or is affixed to other housing segments 102-106 forming the assembled housing 202.

The padlock 206 is well known to those of skill in the art. The padlock 206 may comprise any portable lock comprising a shackle used to protect against theft, vandalism, unauthorized access, and the like. The padlock may be key or combination activated. In some embodiments of the present invention, the functions of the padlock 206 are incorporated into the apparatus 200 such that water faucet anti-theft device 200 comprises an internal locking mechanism preventing unauthorized disassembly of the assembled housing 202.

The padlock 206 comprises a shackle, or a locking bar, which is inserted through the two semi-circular protrusions 208 affixed to the assembled housing 202.

The two semi-circular protrusions 208 are affixed to the assembled housing 202 in such a manner as to prevent disassembly of the housing segments 102-106 forming the assembled housing 202 (the forward housing segment 102, the upper housing segment 104, and the rearward housing segment 106) without unlocking the padlock 206.

In alternate embodiments, the two semi-circular protrusions may comprise intrusions, or holes in the housing segments 102-106, meant to receive the shackle of the padlock 206.

The faucet 108 is substantially described above in relation to FIG. 1A.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A lockable housing configured to prevent unauthorized use of a faucet, the apparatus comprising:
a forward housing segment with two or more spaced-apart walls defining a cavity encapsulating a spout of a faucet, the forward housing segment configured to slide relative to the faucet over the spout and to cover the forward, lateral and lower portions of the faucet;
an upper housing segment comprising two or more spaced-apart walls defining a cavity encapsulating one of the faucet or the forward housing segment, the upper housing segment configured to slide relative to the faucet over the upper and lateral portions of the faucet;
a rearward housing segment configured to slide relative to the faucet behind the faucet, and to cover the rearward portion of the faucet; and
two or more semi-circular protrusions mounted to one or more of the housing segments and configured to receive the locking bar of a padlock once the upper housing segment, rearward housing segment and forward housing segment have been assembled around the faucet (together the “assembled housing”).

2. The apparatus of claim 1, further comprising two or more semi-circular protrusions mounted to one or more of the housing segments in the assembled housing and configured to receive the shackle of a padlock once the upper housing segment, rearward housing segment and forward housing segment have been assembled around the faucet.

3. The apparatus of claim 1, wherein one of the upper housing segment, the rearward housing segment, and the forward housing segment comprise a key-operated latching release mechanism for releasing each of the upper housing segment, the rearward housing segment, and the forward housing segment, after said segments are assembled together, wherein said key-operated latching mechanism is activated with a key or combination.

4. The apparatus of claim 1, wherein the upper housing segment is configured to latchably engage at least one of the forward housing segment one of the rearward housing segment, and wherein the rearward housing segment is configured to latchably engage at least one of the forward housing segment and the upper housing segment.

5. The apparatus of claim 1, wherein the rearward housing segment is rotatably connected to one of the forward housing segment and the upper housing segment.

6. The apparatus of claim 1, wherein the upper housing segment comprises one or more oblong holes through which push-buttons affixed to the one or more of the forward housing segment and the rearward housing segment protrude when the segments are assembled to form the assembled housing, which push-buttons are configured to slidably release one or more housing segments from the assembled housing when depressed.
